(19) United States
(12) Patent Application Publication
(10) Pub. No.: US 2014/0329300 A1
(43) Pub. Date: Nov. 6, 2014

(54) DEVICE FOR ANALYZING A SAMPLE AND METHOD OF USING THE SAME

(71) Applicant: RareCyte, Inc., Seattle, WA (US)

(72) Inventors: Jonathan Lundt, Seattle, WA (US); Joshua Nordberg, Bainbridge Island, WA (US); Daniel Campton, Seattle, WA (US); Steve Quarre, Woodinville, WA (US); Ronald Seubert, Sammamish, WA (US)

(73) Assignee: RareCyte, Inc., Seattle, WA (US)

(21) Appl. No.: 14/265,227

(22) Filed: Apr. 29, 2014

Related U.S. Application Data
(60) Provisional application No. 61/818,256, filed on May 1, 2013.
(60) Provisional application No. 61/883,753, filed on Sep. 27, 2013.

(51) Int. Cl. G01N 1/31

(52) U.S. Cl. CPC G01N 1/31
USPC 435/287.2; 435/288.7

(57) ABSTRACT

This disclosure is directed to a device and method of using the device to analyze a sample. The sample may be a suspension, a portion of the suspension, a particular component of the suspension, or the like. For example, the suspension may be blood, the portion may be buffy coat, and the component may be circulating tumor cells. The device may be used to hold the sample for imaging or further processing. The device comprises a cavity that may be sealed on one side by a porous membrane and on an opposite side by a non-porous cover. The porous membrane allows for reagents to be introduced to the sample without diluting the sample. The non-porous cover allows for imaging of the sample. The device further comprises a nozzle for introducing the sample into a space within the cavity.

### CROSS-REFERENCE TO A RELATED APPLICATION

This application claims the benefit of Provisional Application No. 61/818,256, filed May 1, 2013, and Provisional Application No. 61/883,753, filed Sep. 27, 2013.

### TECHNICAL FIELD

This disclosure relates generally to a device for analysis of a sample, though more specifically, to a slide for culturing, imaging, and/or processing the sample.

### BACKGROUND

Suspensions often include materials of interest that are difficult to detect, extract and isolate for analysis. For instance, whole blood is a suspension of materials in a fluid. The materials include billions of red and white blood cells and platelets in a proteinaccous fluid called plasma. Whole blood is routinely examined for the presence of abnormal organisms or cells, such as fetal cells, endothelial cells, epithelial cells, parasites, bacteria, and inflammatory cells, and viruses, including HIV, cytomegalovirus, hepatitis C virus, and Epstein-Barr virus and nucleic acids. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 3 CTCs is considered clinically relevant in the diagnosis and treatment of a cancer patient. However, detecting even 1 CTC in a 7.5 ml blood sample may be clinically relevant and is equivalent to detecting 1 CTC in a background of about 50 billion red and white blood cells. Using existing techniques to find, isolate and extract as few as 3 CTCs of a whole blood sample is extremely time consuming, costly and is extremely difficult to accomplish.

As a result, practitioners, researchers, and those working with suspensions continue to seek systems and methods to more efficiently and accurately detect, isolate and extract samples of a suspension.

### DESCRIPTION OF THE DRAWINGS

FIGS. 1A-1H show an example device.

FIG. 1I shows an example device.

FIGS. 2A-2B show the example device.

FIGS. 3A-3B show the example device.

FIGS. 4A-4B show an example device.

FIGS. 5A-5B show example caps.

FIG. 6 shows a flowchart for using the example device.

FIG. 7 shows an imaging process.

### DETAILED DESCRIPTION

This disclosure is directed to a device and method of using the device to analyze a sample. The sample may be a suspension, a portion of the suspension, a particular component of the suspension, or the like. For example, the suspension may be blood, the portion may be buffy coat, and the component may be circulating tumor cells. The device, such as a slide, may be used to hold the sample for imaging or further processing. The device comprises a cavity that may be sealed on one side by a porous membrane and sealed on an opposite side by a non-porous cover. The porous membrane allows for reagents to be introduced to the sample without diluting the sample. The non-porous cover allows for imaging of the sample. The device further comprises a nozzle for introducing the sample into a space within the cavity.

### Device

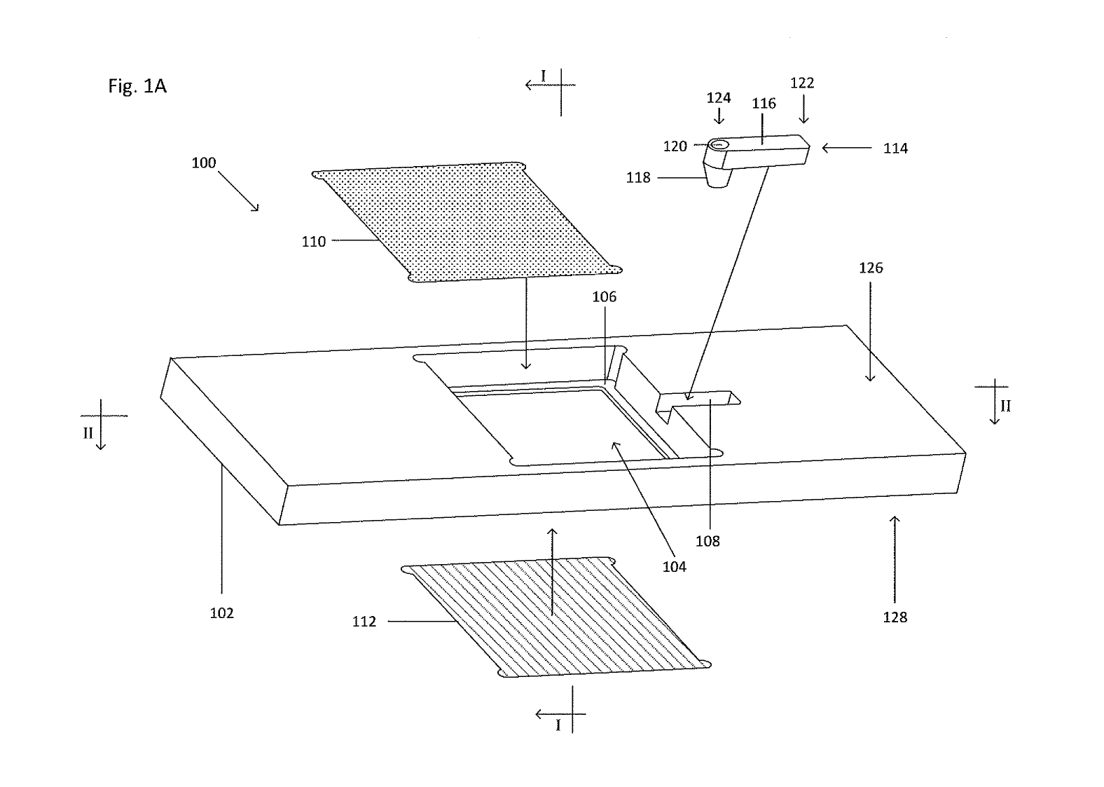

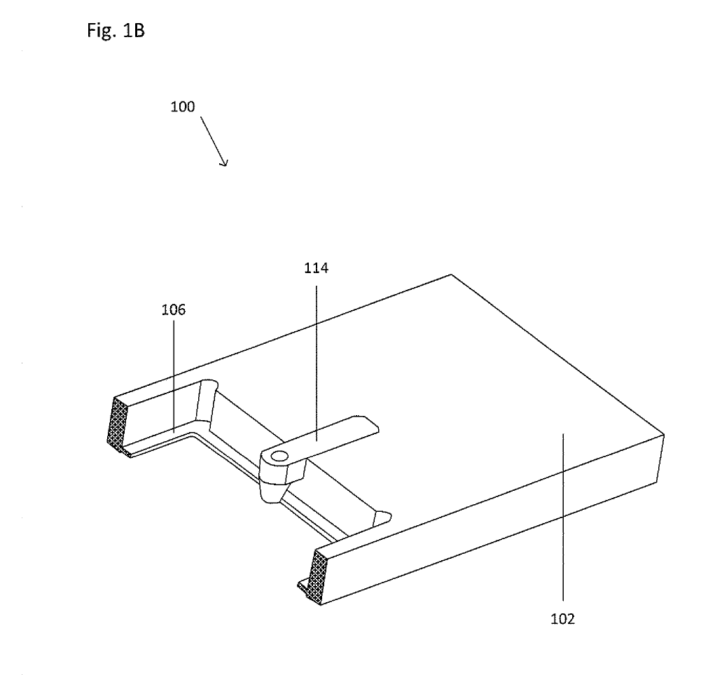

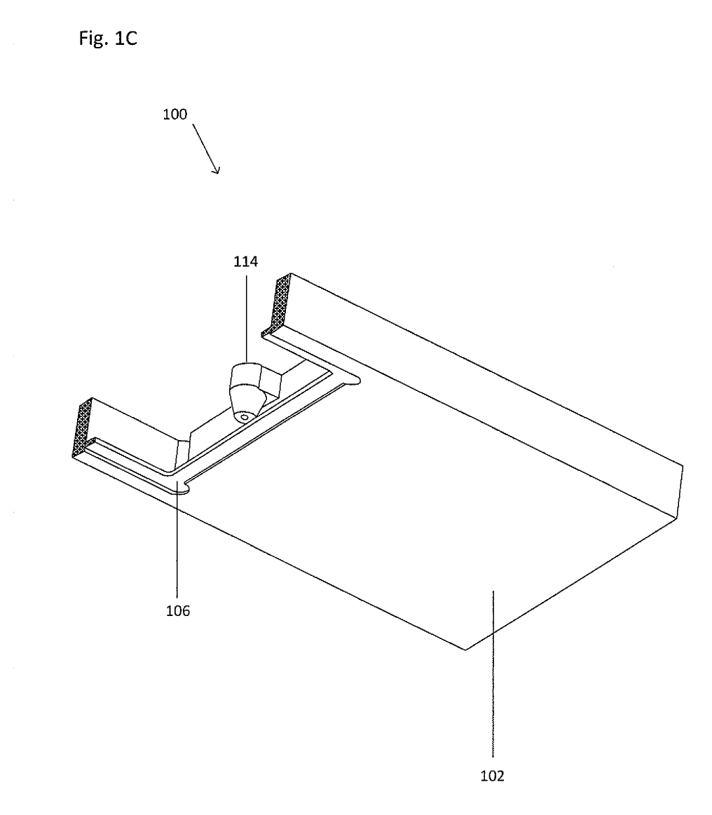

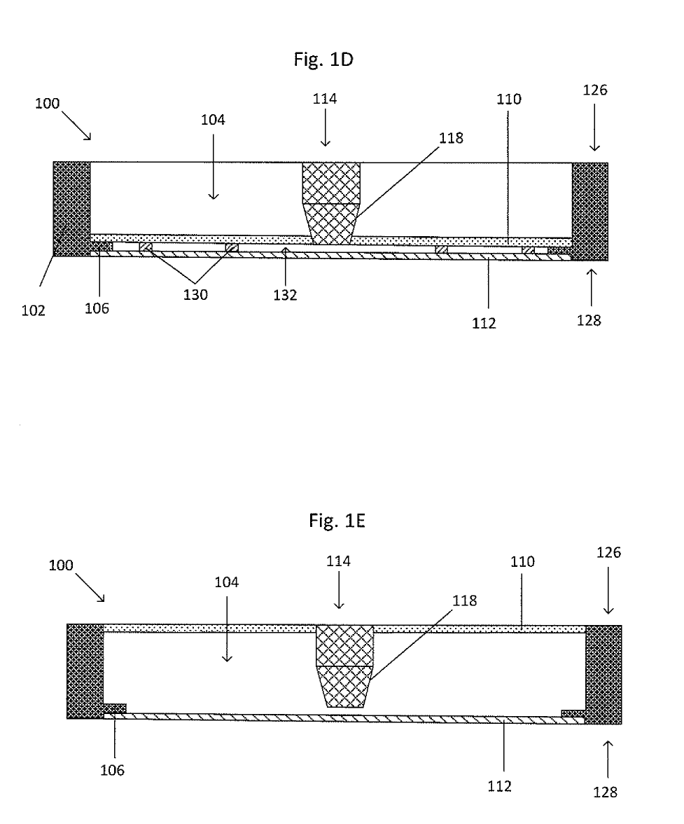

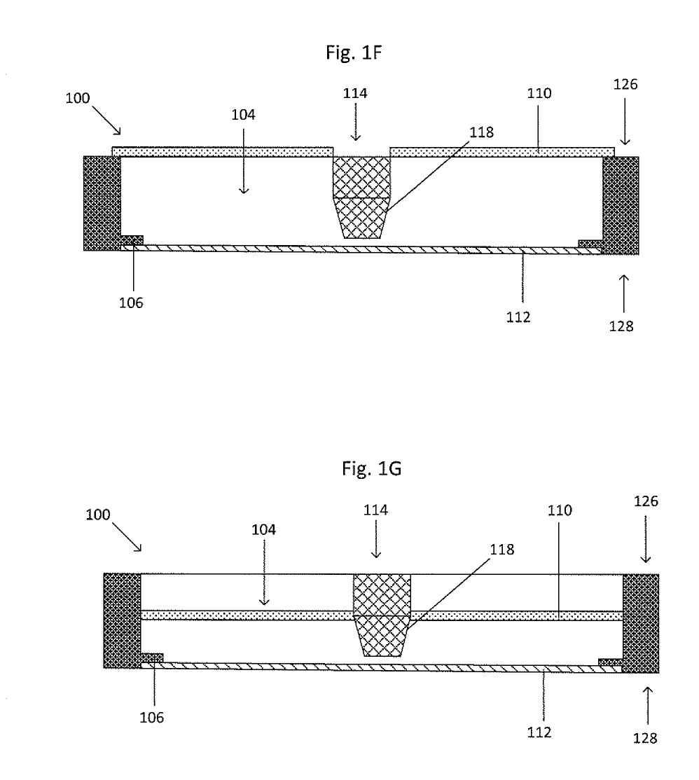

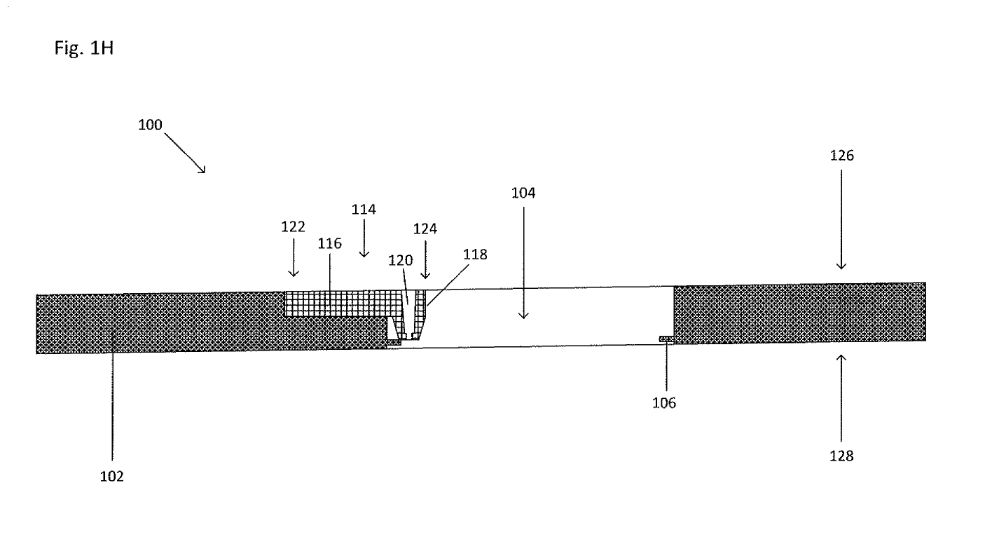

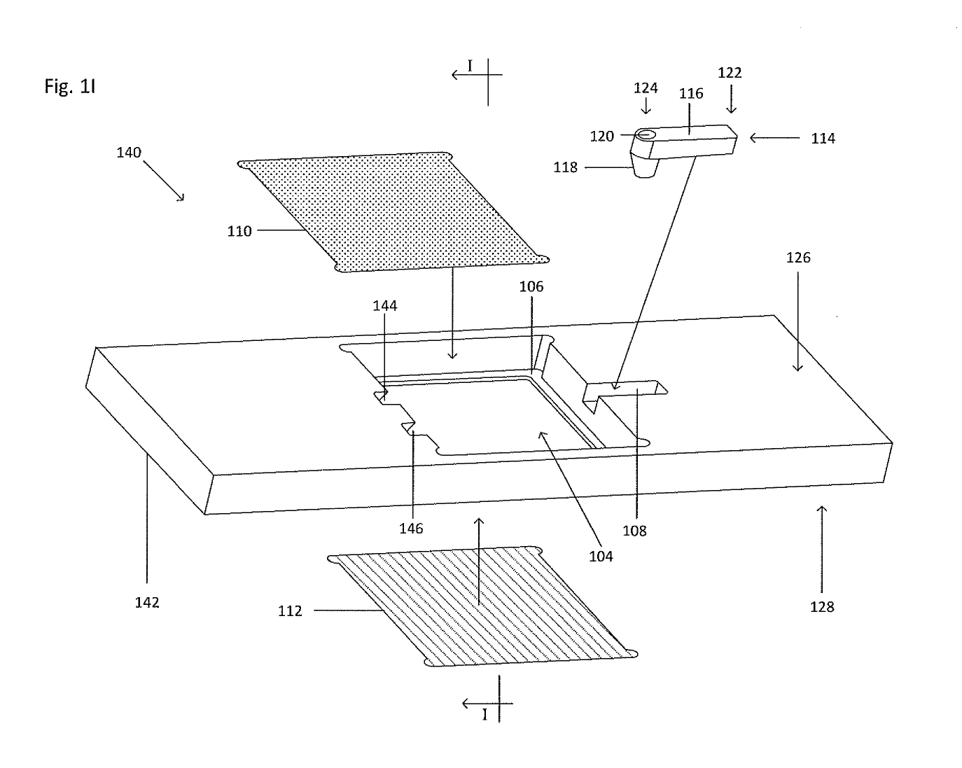

FIG. 1A shows an exploded isometric view of a device 100. The device 100, such as a slide, includes a main body 102 having a first side 126 and a second side 128 and a non-porous cover 112. The device 100 may also include a porous membrane 110. The device 100 may also include a nozzle 114. The main body 102 includes a cavity 104 that spans the thickness of the main body 102. The cavity 104 includes a shelf 106 which extends partially from inner walls of the main body 102—the inner walls defining the bounds of the cavity 104 towards the center of the cavity 104. The main body 102 may be any appropriate shape, including, but not limited to a square, a rectangle, a circle, an oval, an ellipse, a tetrahedron, a triangle, a polyhedron, or the like. The cavity 104 and the shelf 106 may be any appropriate shape, including, but not limited to a square, a rectangle, a circle, an oval, an ellipse, a tetrahedron, a triangle, a polyhedron, or the like. FIGS. 1B and 1C show cross-sectional isometric views of the device 100 taken along the line I-I, the porous membrane 110 and the non-porous cover 112 having been removed for illustrative purposes.

FIG. 1D shows a fully assembled cross-section of the device 100 taken along the line I-I shown in FIG. 1A. When the device 100 is fully assembled, a sample may be located between the porous membrane 110 and the non-porous cover 112. The sample may be a suspension, a portion of the suspension, particular component of the suspension, or the like. A space 132 between the porous membrane 110 and the non-porous cover 112 forms a sample layer. The distance between the porous membrane 110 and the non-porous cover 112 may be supported by one or more support members 130 that span the distance between the porous membrane 110 and the non-porous cover 112. The support members 130 may be, but are not limited to, beads, such as polymeric beads (i.e. polystyrene), posts (any appropriate shape including columnar, spherical, rectangular, triangular, polyhedral, or the like), or the like. The support members 130 may be integrated into the porous membrane 110, the non-porous cover 112, or both; or, the support members 130 may be separate pieces from the porous membrane 110 and the non-porous cover 112. The support members 130 maintain the distance between the porous membrane 110 and the non-porous cover 112 by inhibiting any inward or outward deformation (such as bowing out or caving in) of the porous membrane 110 or the non-porous cover 112. The distance between the porous membrane 110 and the non-porous cover 112 may be less than or equal to approximately 1000 μm, such as approximately 300 μm, approximately 100 μm, approximately 60 μm, approximately 50 μm approximately 40 μm, or approximately 25 μm. The distance space may also permit capillary action or wicking in order to draw the sample from one side of the space to the other.

As shown in FIG. 1D, the porous membrane 110 may be placed on a first side of the shelf 106. Alternatively, the porous membrane 110 may be placed at a first side of the cavity 104, as shown in FIG. 1E, on the first side of the cavity 104, as shown in FIG. 1F, or any distance within the cavity 104 between the first and second sides 126 and 128, as shown in FIG. 1G. The porous membrane 110 includes pores sized to prevent the sample from passing through the porous membrane 110, thereby only allowing at least one molecule, such as that from a reagent, a gas, a solution or another suspension, to pass through, such as by passive (i.e. diffusion) or active (i.e. a pressure gradient) action. The number of pores, pore spacing, and pore size may be varied. The size and/or shape may differ from pore to pore. The pores may be any appropriate shape, including, but not limited to, circular, elliptical, triangular, rectangular, quadrilateral, or polyhedral. The pore size may be less than 1 μm, equal to 1 μm, or greater than 1 μm. The porous membrane 110 be made of any material that is porous or may be made porous (such as by track-etching, laser ablation, ion-etching, or any appropriate method by making a material porous), including, but not limited to polycarbonate, Teflon, parylene, polyether ether ketone (“PEEK”), or the like. The porous membrane 110 may be secured to the shelf 106 by welding, such as ultrasonic, thermal, or laser; an adhesive, such as cyanoacrylate, an epoxy, vacuum grease, such as high vacuum silicone grease; clips, detents, press fit, or interference fit; or the like. Furthermore, the porous membrane 110 may be puncturable, such as by a needle, sharpened pipet tip, or the like. The porous membrane 110 may be a sterility filter to permit gas exchange while inhibiting contamination. The sterility filter may also allow for media exchange to nourish the sample.

The shelf 106 may be located at any height within the cavity 104. For example, the shelf 106 may be located at a distance from the second side that is equal to the height of the non-porous cover 112, such that when the non-porous cover is placed on the shelf 106, the non-porous cover 112 is flush with the second side of the main body 102. The location of the shelf 106 within the cavity 104, such as by being closer to the second side of the main body 102 than the first side of the main body 102, may also form a chamber above the porous membrane 110 into which reagents, such as fixatives, permeabilizing agents, and/or labeling agents, may be introduced, as the pores of the porous membrane 110 allow for the molecules of the reagents to enter the sample layer. The reagent may be added to the chamber and then aspirated off (or removed by any appropriate method) after an appropriate amount of time has passed to permit the molecules to cross the porous membrane 110 and interact with the sample. Alternatively, the reagent may be introduced between the porous membrane 110 and the non-porous cover 112 with the sample sitting on top of the porous membrane 110.

The non-porous cover 112 may be placed at the second side of the cavity 104 or on a second side of the shelf 106. The non-porous cover 112 provides a window through which the sample may be imaged. The non-porous cover 112 may allow for the use of various magnification objectives, such as up to 100×, including 10×, 40×, 60×, and 63×. The non-porous cover 112 may be transparent or semi-transparent. The non-porous cover 112 may be secured to the shelf 106 by welding, such as ultrasonic, thermal or laser; an adhesive, such as cyanoacrylate, an epoxy, vacuum grease, such as high vacuum silicone grease clips, detents, press fit, or interference fit; or the like. The non-porous cover 112 may be optically clear to permit imaging of the sample within the cavity 104.

The non-porous cover 112 may be composed of glass, crystal, plastic, or combinations thereof. Alternatively, the non-porous cover 112 may be embedded within the main body 102 and, therefore, not removable.

FIG. 1H shows a cross-section of the device 100 taken along the line II-II shown in FIG. 1A, the porous membrane 110 and the non-porous cover 112 having been removed for illustrative purposes. As shown in FIGS. 1A, 1B, and 1H, the main body 102 includes a slot 108 shaped to receive the nozzle 114. The nozzle 114 includes an arm 116 with an inner end 124 and an outer end 122. The inner end 124 of the arm 116 extends into the cavity 104. The outer end 122 of the arm 116 sits within the slot 108. The inner end 124 includes a tip 118 and a bore 120 that narrows to the tip 118. The opening of the bore 120 may interface or mate with a device for introducing the sample, such as a pipette, a syringe, or the like. The diameter of the bore 120 may be uniform, tapered, or may change step-wise (i.e. going from a larger diameter to a small diameter, or vice versa, with no progressive change). The diameter of the bore 120 may be selected to inhibit backflow, thereby causing directional flow, because of the surface tension of the fluid (i.e. the sample or a solution) introduced through the nozzle 114. The nozzle 114 may be attached to the slot 108 by an adhesive, an epoxy, vacuum grease, a screw, a tongue-and-groove joint, a dovetail joint, an interference fit, a press fit, a clasp, detents, or the like. Alternatively, the nozzle 114 and the main body 102 may be one piece. A portion of the tip 118 may contact the shelf 106, or the tip 118 may not contact the shelf 106 at all. The device 100 may include more than one nozzle based on the size of the cavity so as to permit equal distribution of the sample and/or quicker and more efficient loading. Alternatively, a re-sealable port, through which the sample may be introduced into the sample layer, may be included on a sidewall of the main body 102, such that the re-sealable port and sample layer are at equal heights within the main body 102. Alternatively, the bore 120 may include a one-way valve to inhibit backflow.

FIG. 1I shows an exploded isometric view of a device 140. The device 140 is similar to the device 100 except that a main body 140 of the device 140 may include an inlet port 144 and an outlet port 146 to create a flow chamber, by which a reagent is introduced via the inlet port 144, flowed across the chamber, and then removed via the outlet port 146. The inlet and outlet ports 144 and 146 may be on the first side of the main body 102 and anywhere along an edge of the cavity 104 (e.g. adjacent, opposite, or any appropriate angle or distance away from each other).

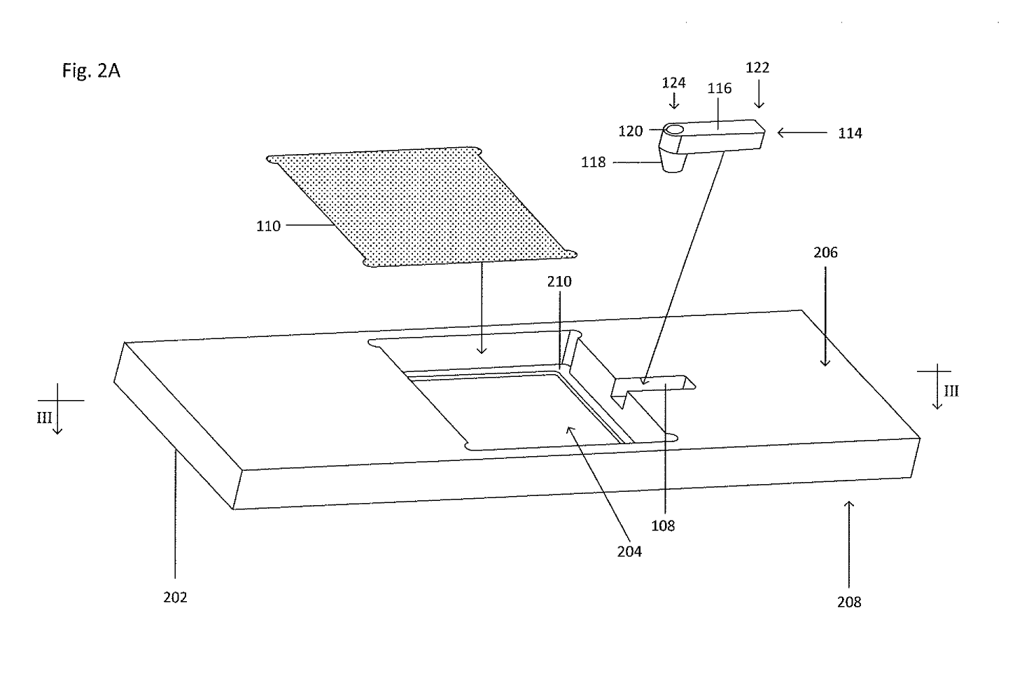

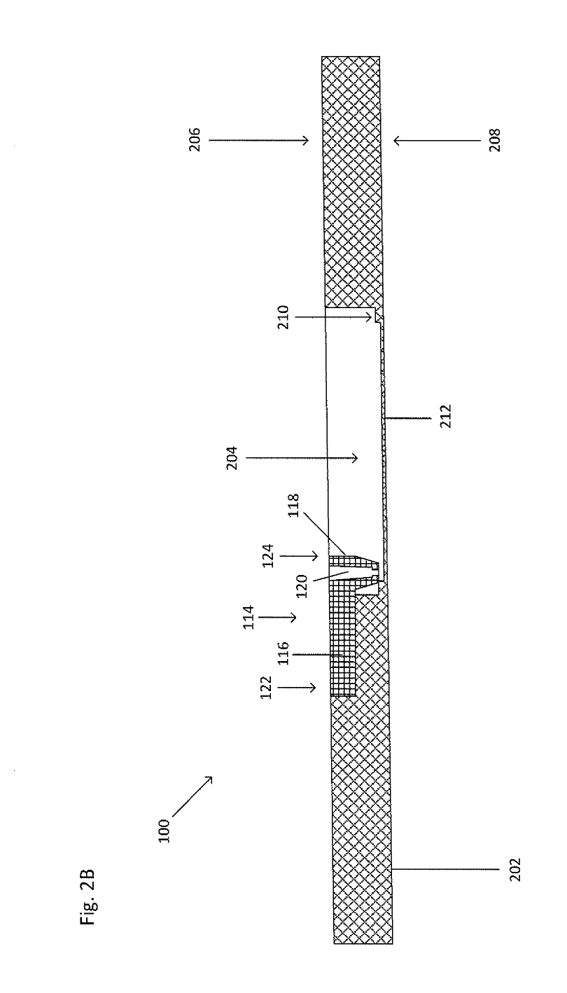

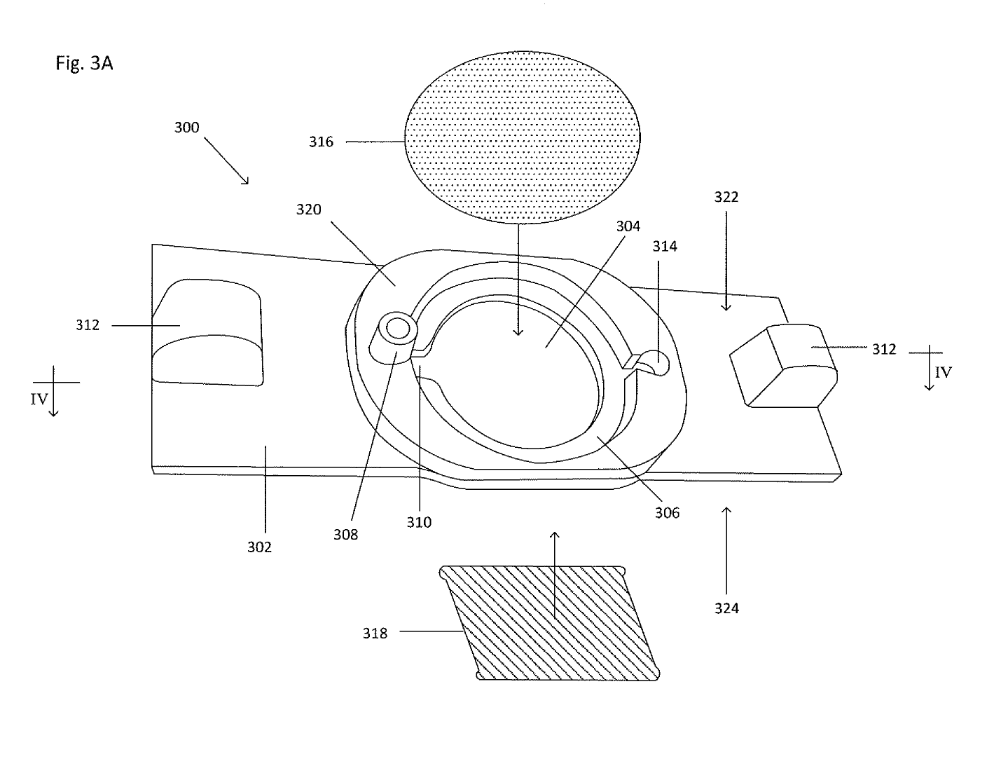

FIG. 2A shows an exploded isometric view of a device 200. FIG. 2B shows a cross-section of the device 200 taken along the line shown in FIG. 2A. The device 200 is similar to the device 100 except that device 200 includes a main body 202 with a cavity 204 that partially spans the thickness of the main body 202. A portion 212 of the main body 202 that seals that cavity 204 may be optically clear to allow for imaging. The device 200 may also include a shelf 210.

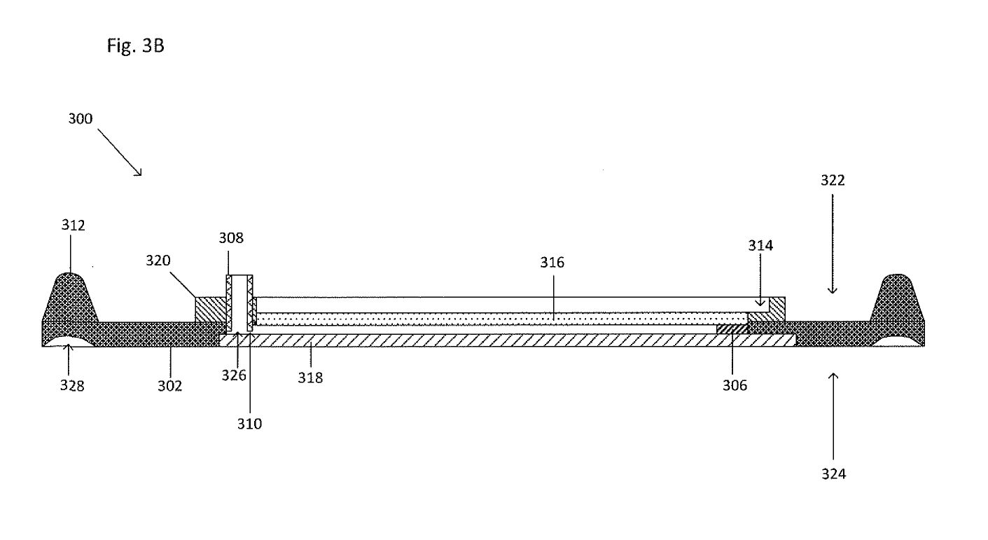

FIG. 3A shows an exploded view of an example device 300. FIG. 3B device shows a cross-section of the example device taken along the line IV-IV shown in FIG. 3A. The device 300 is similar to the device 100 except that a cavity 304 and a shelf 306 are circular. In this example, the cavity 304 is located in a central portion of a main body 302 and is formed from at least one inner wall which defines the outer boundary of the cavity 304. The shelf 306 extends inwardly from the inner wall. A nozzle 308 to introduce the sample into the cavity 304 is integrated into a rim 320 which extends up from the main body 302 and surrounds at least a portion of the cavity 304. Alternatively, the nozzle 308 may be integrated into the main body 302. The device 300 may include more than one nozzle based on the size of the cavity so as to permit equal distribution of the sample and/or quicker and more efficient loading. The nozzle 308 may introduce the sample on top of the porous membrane 316 or between the porous membrane 316 and the non-porous cover 318. For example, the nozzle 308 may be in fluid communication with the cavity 304 via a channel 326. The channel 326 may extend from a bottom opening of the nozzle 308 to the cavity 304 via a gap 310 in the shelf 306. The device 300 may also include a porous membrane 316 and a non-porous cover 318. The non-porous cover 318 may be placed within a cover cut-out 330 on the second side 324 of the main body 302, may be placed on a second side of the shelf 306, or may be placed on the second side 324 of the main body 302. The non-porous cover 318 may be circular, may be rectangular with legs extending away from opposite sides, or may be a combination in which a circular section is a first material and the remaining portions of the rectangle and legs are a second material.

The diameter of the nozzle 308 may be selected to inhibit backflow, thereby causing directional flow. The diameter of the nozzle 308 may inhibit backflow because of the surface tension of the fluid (i.e. the sample or a solution) introduced through the nozzle 308. Alternatively, the nozzle 308 may include a re-sealable port. Alternatively, the nozzle 308 may include a one-way valve to inhibit backflow.

The device 300 may also include grips 312. The grips 312 allow the device 300 to be easily grabbed, manipulated, and transported. A bottom side of the grips 312 each include a a recess 328 to receive the respective grip 312 of another device. The grip-recess connection permits devices to be stacked on top of one another for ease of storage and transportation.

The device 300 may also include an outlet port 314 to remove reagents added to the cavity 304 on top of the porous membrane 316. The porous membrane 316 permits diffusion of the reagents while preventing the sample from leaking out of the porous membrane 316 or being diluted by the solvent or fluid portion of the reagents. The outlet port 314 may be integrated into the main body 302. Alternatively, the outlet port 314 may be integrated into the rim 320 extending up from the main body 302. Alternatively, the reagents may be flowed through the sample and removed via the outlet port 314. The outlet port 314 may include a filter to retain the target analytes within the cavity 304 while withdrawing the reagents. Alternatively, the reagent may be introduced between the porous membrane 316 and the non-porous cover 318 with the sample sitting on top of the porous membrane 316.

Alternatively, the outlet port 314 may be sized and shaped to accept a processing vessel, such as a PCR tube. The processing vessel holds a target analyte of the sample that has been picked and isolated for further processing. The device 300 may also include an insert (not shown) to fit into the cavity 304 to reduce the volume of the cavity 304. The insert (not shown) may be the same shape as the cavity 304 with a cut-out substantially central to the insert (not shown), such that the cut-out is the area in which the sample may be found.

The porous membrane 316 may be removable. For example, the porous membrane 316 may be peeled or pulled off, or, the porous membrane 316 may be attached to a cap that fits within the cavity 304.

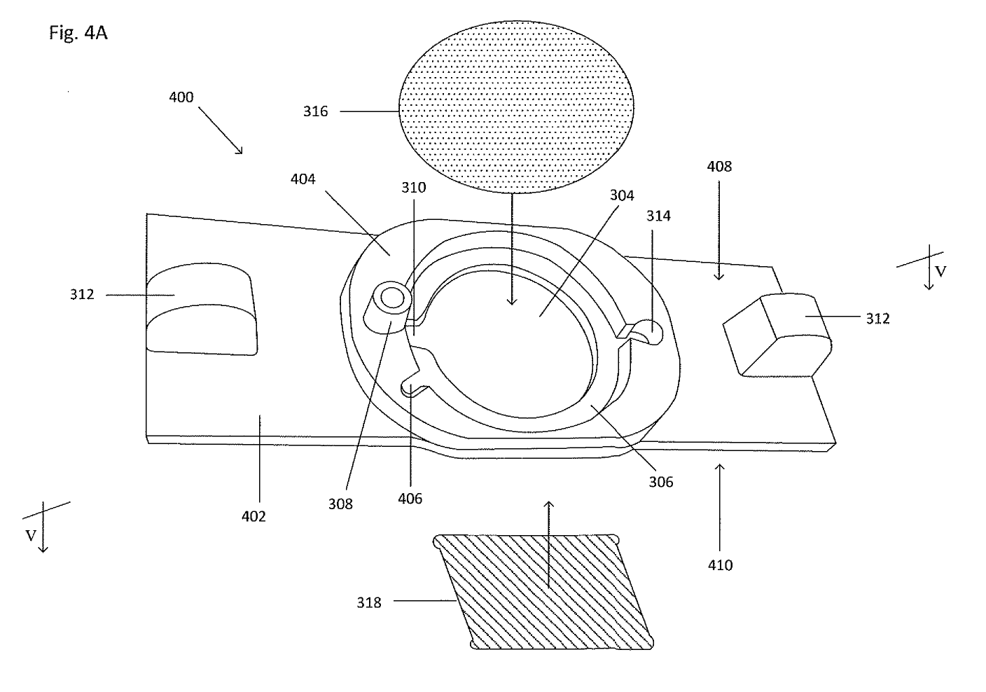

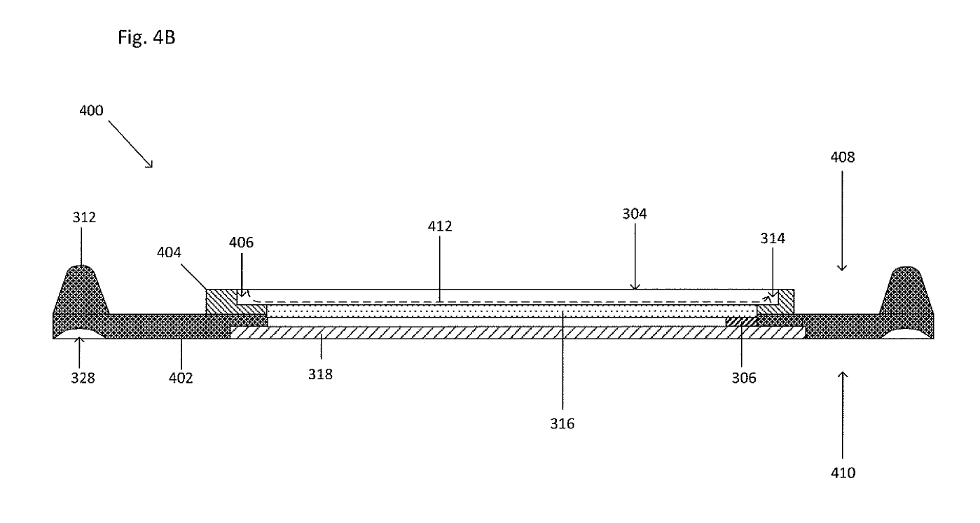

FIG. 4A shows an exploded view of an example device 400. FIG. 4B shows a cross-section of the example device taken along the line V-V shown in FIG. 4A. The device 400 is similar to the device 300 except that the device 400 may also include an inlet port 406 in the rim 404 or the main body 402 to create a flow chamber, by which reagents are introduced by the inlet port 406, flowed across the porous membrane 316, and then removed via the outlet port 314. A dashed line 412, as shown in FIG. 4B, shows how the reagents may flow from the inlet port 406 to the outlet port 314.

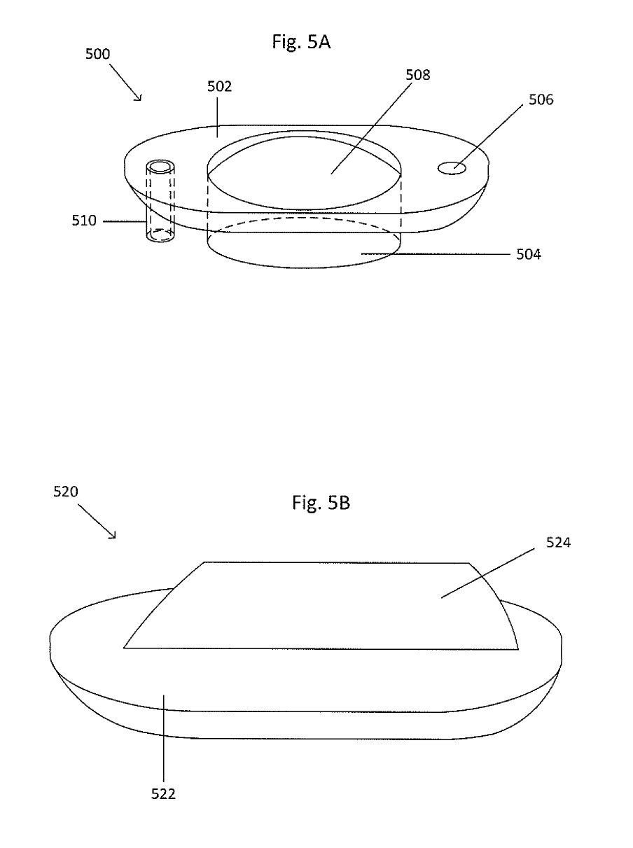

FIG. 5A shows an example cap 500. The cap 500 includes a base 504 and a top 502. The base 504 fits within a cavity of a device, such as the cavity 304 of the device 300 described above. A porous membrane may be attached to the base 504 such that the porous membrane sits on a shelf of the device and is also removable from the shelf. The cap 500 may include a hole 506 to fit over a nozzle without blocking the nozzle. The cap 500 may also include an aperture 508 which traverses the entire height of the removable cap 500 from the top 502 through the base 504. The aperture 508 permits reagents to be introduced to the device when the removable cap 500 is inserted into the cavity. The removable cap 500 may also include an outlet extension 510 to fit into an outlet port and to permit removal of a fluid. The outlet extension 510 is a column that extends from the top 502 and includes a bore to permit removal of the fluid. The column may fit within the outlet port 314.

FIG. 5B shows another example sealing cap 520. The sealing cap 520 covers and seals a cavity of a device. The sealing cap 500 fits over at least a portion of a main body of the device. The sealing cap 520 includes a base 522 and a fin 524 to enable gripping for removal from the device and placement on the device.

The main body may be composed of glass, crystal, plastic, metal, or combinations thereof. The sample may undergo subsequent processing which includes techniques for sequencing, such as nucleic acid sequencing, extracellular analysis and/or intracellular protein analysis such as intracellular protein staining, in situ hybridization (“ISH”), or branched DNA (“bDNA”) analysis.

Alternatively, the main body may include more than one cavity, such as a microtiter plate, such that one or more porous membranes seal one, some, or all of the cavities. When more than one cavity is included, the main body may also include one or more nozzles to be in fluid communication with one, some or all of the cavities.

### Method

For the sake of convenience, the sample discussed herein is a buffy coat, though the suspension may be urine, blood, bone marrow, cystic fluid, ascites fluid, stool, semen, cerebrospinal fluid, nipple aspirate fluid, saliva, amniotic fluid, vaginal secretions, mucus membrane secretions, aqueous humor, vitreous humor, vomit, any other physiological fluid or semi-solid, and portions (i.e. plasma or buffy coat from blood) or components (i.e. analytes) of a suspension. Furthermore, the analyte may be a circulating tumor cell (“CTC”), though the target analyte may be a cell, such as ova, a circulating endothelial cell, a fetal cell, a nucleated red blood cell, a vesicle, a liposome, a protein, a nucleic acid, a biological molecule, a naturally occurring or artificially prepared microscopic unit having an enclosed membrane, parasites, microorganisms, viruses, or inflammatory cells.

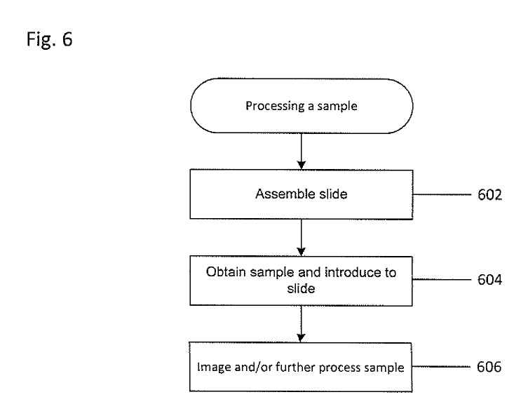

FIG. 6 shows a flow diagram for processing a sample. In block 602, the device 100 is assembled. For the sake of convenience, the assembly method discussed herein is one method of assembling the device 100, though the device 100 may be assembled by re-ordering steps or by having components pre-assembled or pre-formed as singular components. To assemble the device 100, the main body 102 is provided. The porous membrane 110 is then rested on and secured to the shelf 106 by an adhesive, such as cyanoacrylate, an epoxy, vacuum grease, such as high vacuum silicone grease, or the like. The nozzle 114 is then inserted into and attached to the slot 108 by an adhesive, an epoxy, vacuum grease, a screw, a tongue-and-groove joint, a dovetail joint, an interference fit, a press fit, a clasp, detents, or the like. The porous membrane 110 may include a pre-formed hole or slit into which the tip 118 of the nozzle 116 may fit so as to permit the sample to be introduced into the sample layer. Alternatively, when no pre-formed hole or slit is present on the porous membrane 110, a hole may be cut into the porous membrane 110 after the porous membrane 110 has been secured to the shelf 106 and the nozzle 114 has been attached to the slot 108. The non-porous cover 112 may then be secured to the shelf 106.

Returning to FIG. 6, in block 604, the sample may be introduced into the sample layer by expelling the sample from a pipette, a syringe, or the like into and through the nozzle 114. A filling fluid may also be added to the sample layer to remove air. The filling fluid may include, but is not limited to, phosphate buffered saline, fluorinated liquids, such as perfluoroketones, perfluorocyclopentanone, perfluorocyclohexanone, fluorinated ketones, hydrofluoroethers, hydrofluorocarbons, perfluorocarbons, and perfluoropolyethers; silicon and silicon-based liquids, such as phenylmethyl siloxane. The nozzle 114 may then be sealed once the sample has been added to the sample layer or once the sample and the filling fluid have been added to the sample layer.

Reagents may be added to the sample layer via the nozzle 114 or inlet port 144 or flowed on top of the porous membrane via the inlet and outlet ports 144 and 146. The reagents, such as antibodies, chemicals to induce changes, permeabilizing agents, fixatives, and/or labeling agents, may be introduced. The pores of the porous membrane 110 allow for the molecules of the reagents to enter the sample layer and interact with the sample. The reagents may include, but are not limited to, fixing agents (such as formaldehyde, formalin, methanol, acetone, paraformaldehyde, or glutaraldehyde), detergents (such as saponin, polyoxyethylene, digitonin, octyl β-glucoside, octyl β-thioglucoside, 1-S-octyl-β-D-thioglucopyranoside, polysorbate-20, CHAPS, CHAPSO, (1,1,3,3-Tetramethylbutyl)phenyl-polyethylene glycol, polyoxyethylene octyl phenyl ether, or octylphenol ethylene oxide), or labeling agents (such as fluorescently-labeled antibodies, enzyme-conjugated antibodies, Pap stain, Giemsa stain, or hematoxylin and eosin stain). The reagents may be removed, such as by aspirating off (or removed by any appropriate method) after an appropriate amount of time has passed to permit the molecules to cross the porous membrane 110 and interact with the sample. Alternatively, when the main body 102 includes the inlet port (not shown) and the outlet port (not shown), the reagents may be removed via the outlet port (not shown). The reagents may be added and removed at different times or simultaneously.

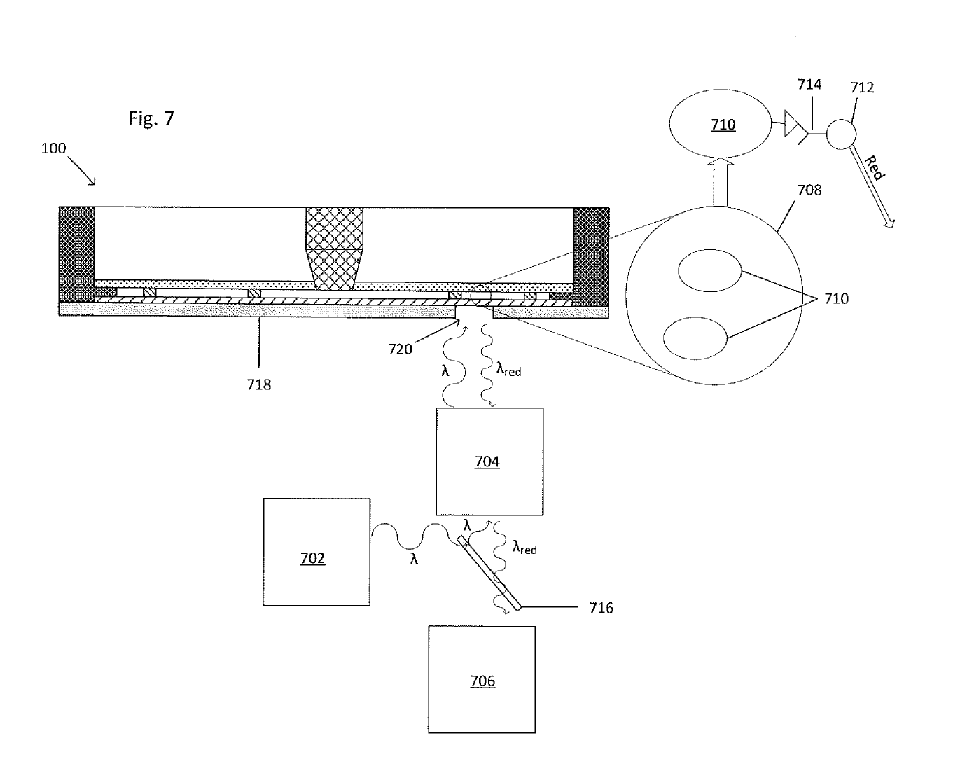

In block 606, the sample may be imaged through the non-porous cover 112 or processed through the porous membrane 110. FIG. 7 shows an imaging process. To image the device 100, the sample layer is illuminated with one or more wavelengths of excitation light from a light source 702, such as red, blue, green, and ultraviolet. A solution containing the fluorescent marker may be used to label at least one component of the sample 710, thereby providing a fluorescent signal for identification and characterization. The solution containing the fluorescent marker may be added to the suspension before the suspension is added to the vessel, after the suspension is added to the vessel but before centrifugation, or after the suspension has undergone centrifugation. The fluorescent marker includes a fluorescent molecule 712 bound to a ligand 714. The sample 710 may have a number of different types of targets. Each type of target is a molecule, such as an antigen, capable of attaching a particular ligand, such as an antibody. As a result, ligands may be used to classify the target analyte and determine the specific type of target analytes present in the suspension by conjugating ligands that attach to particular targets with a particular fluorescent molecule. Examples of suitable fluorescent molecules include, but are not limited to, quantum dots; commercially available dyes, such as fluorescein, FITC (“fluorescein isothiocyanate”), R-phycoerythrin (“PE”), Texas Red, allophycocyanin, Cy5, Cy7, cascade blue, DAPI (“4′,6-diamidino-2-phenylindole”) and TRITC (“tetramethylrhodamine isothiocyanate”); combinations of dyes, such as CY5PE, CY7APC, and CY7PE; and synthesized molecules, such as self-assembling nucleic acid structures. Many solutions may be used, such that each solution includes a different type of fluorescent molecule bound to a different ligand.

The device 100 may be placed on a stage 718 with an aperture 720. The excitation light may be reflected by a dichroic mirror 716 and focused by an objective 704 through the aperture 720 and onto the sample layer, which is the space between the porous membrane and the non-porous cover. The different wavelengths excite different fluorescent markers, causing the fluorescent markers to emit light at lower energy wavelengths. A portion of the light emitted by the fluorescent markers is captured by the objective 704, passed through the dichroic mirror 716, and transmitted to a detector 706 that generates images that are processed and analyzed by a computer or associated software or programs. The images formed from each of the markers may be overlaid when a plurality of fluorescent markers, having bound themselves to the target analyte, are excited and emit light. The sample 710 may then be characterized based on the light emission(s) from the fluorescent marker(s) attached to the sample 710. Alternatively, or in addition to, the sample may be imaged using transmitted light, such as by bright field, dark field, phase contrast, differential interference contrast, or the like.

The sample or a sample portion may be subsequently processed by removing the porous membrane or the non-porous cover to extract the sample or the sample portion; or, the porous membrane may be punctured, such as by a syringe or the like, to remove the sample. These process may include, but are not limited to, extracellular and intracellular analysis including intracellular protein labeling; nucleic acid analysis, including, but not limited to, whole genome amplification followed by next generation sequencing, expression arrays, protein arrays, and DNA hybridization arrays, including genomic hybridization arrays; in situ hybridization (“ISH”—a tool for analyzing DNA and/or RNA, such as gene copy number changes); polymerase chain reaction (“PCR”); reverse transcription PCR; or branched DNA (“bDNA”—a tool for analyzing DNA and/or RNA, such as mRNA expression levels) analysis. These techniques may require fixation, permeabilization, and isolation of the sample prior to analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, c-myc, caspases, survivin, p27^{kip}, FOXC2, BRAF, Phospho-Akt1 and 2, Phospho-Erk1/2, Erk1/2, P38 MAPK, Vimentin, ER, PgR, PI3K, pFAK, KRAS, ALKH1, Twistl, Snaill, ZEB1, Fibronectin, Slug, Ki-67, M30, MAGEA3, phosphorylated receptor kinases, modified histones, chromatin-associated proteins, and MAGE.

A device may also be used to culture, for example, a cell line. The cells may be introduced through the nozzle and nourished with media through the porous membrane. The culture may be kept sterile because of the porous membrane, such as sterility filter.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the an to best utilize this disclosure and various embodiments with various modifications as are suited to the particular use contemplated. It is intended that the scope of this disclosure be defined by the following claims and their equivalents:

I/we claim:

1. A device comprising:
a main body including at least one cavity that partially spans the thickness of the main body; and
at least one nozzle on a first side of the main body to introduce a sample that may contain at least one target analyte into the at least one cavity.

2. The device of claim 1, further comprising at least one porous membrane to enclose at least a portion of the at least one cavity, wherein the enclosed portion of the cavity forms a sample layer.

3. The device of claim 2, wherein the at least one porous membrane is optically clear to permit imaging.

4. The device of claim 2, further comprising:
a shelf within the at least one cavity to set a height of the sample layer, and
the at least one porous membrane to be placed on a first side of the shelf.

5. The device of claim 2, wherein the at least one porous membrane is a sterility filter that permits gas exchange and media exchange for sample nourishment and inhibits sample contamination.

6. The device of claim 2, wherein the sample layer has a height that is less than or equal to approximately 1000 μm.

7. The device of claim 2, wherein the sample layer has a height that induces capillary action to withdraw the sample from a sample dispensing apparatus.

8. The device of claim 1, further comprising an outlet port integrated into the main body to hold a processing vessel.

9. The device of claim 1, further comprising an outlet port to remove a portion of at least one reagent introduced to the at least one cavity.

10. The device of claim 1, further comprising at least one non-porous cover to seal the cavity on a second side of the main body, wherein the at least one cavity fully spans the thickness of the main body.

11. The device of claim 10, further comprising:
an outlet port integrated into the main body to remove a portion of at least one reagent introduced to the at least one cavity; and
at least one porous membrane to enclose a portion of the at least one cavity, wherein the enclosed portion of the cavity forms a sample layer.

12. The device of claim 10, wherein the at least one non-porous cover is optically clear to permit imaging.

13. The device of claim 10, wherein the at least one non-porous cover is embedded within the main body.

14. The device of claim 13, wherein the at least one non-porous cover is optically clear to permit imaging.

15. The device of claim 1, wherein the at least one nozzle is integrated into the main body and is in fluid communication with the at least one cavity.

16. The device of claim 15, further comprising a plurality of nozzles to load the sample, a solution, or a fluid.

17. The device of 15, further comprising an outlet port integrated into the main body and in fluid communication with the at least one cavity.

18. The device of claim 17, further comprising at least one porous membrane to enclosed at least a portion of the at least one cavity, wherein the at least one nozzle introduces the sample above or below the at least one porous membrane.

19. The device of claim 1, further comprising at least one removable cap to seal an open side of the at least one cavity.

20. The device of claim 1, further comprising a plurality of nozzles to load the sample, a solution, or a fluid.

21. The device of claim 1, wherein the nozzle is integrated into a rim of the main body, wherein the rim extends away from the first side of the main body.

22. The device of claim 21, further comprising an outlet port in fluid communication with the at least one cavity integrated into the rim.

23. The device of claim 22, further comprising at least one porous membrane to enclose at least a portion of the at least one cavity.

24. The device of claim 1, further comprising:
an outlet port in fluid communication with the at least one cavity integrated into the main body to remove a portion of at least one reagent introduced to the at least one cavity; and
a filter within the outlet port to retain the sample within the at least one cavity to withdraw the portion of the at least one reagent.

25. The device of claim 1, further comprising:
an inlet port on the first side of the main body to introduce at least one reagent into the at least one cavity; and
an outlet port in fluid communication on the first side of the main body to create a flow chamber by which at least one reagent flows across the cavity and is then removed via the outlet port.

26. The device of claim 1, wherein the main body is a microscope slide.

27. A device comprising:
a main body including at least one cavity that partially spans the thickness of the main body;
at least one nozzle on a first side of the main body to introduce a sample that may contain at least one target analyte into the at least one cavity;
at least one porous membrane to be placed on a first side of a shelf to enclose at least a portion of the at least one cavity, wherein the enclosed portion of the cavity forms a sample layer; and
the shelf within the at least one cavity to set the height of the sample layer.

28. A device comprising:
a main body including at least one cavity that partially spans the thickness of the main body;
at least one nozzle on a first side of the main body to introduce a sample that may contain at least one target analyte into the at least one cavity;
at least one porous membrane to enclose at least a portion of the at least one cavity, wherein the enclosed portion of the cavity forms a sample layer; and
an outlet port in fluid communication with the at least one cavity integrated into the main body.
